(19) United States
(12) Patent Application Publication
(10) Pub. No.: US 2013/0314659 A1
(43) Pub. Date: Nov. 28, 2013

(54) LIQUID CRYSTAL PANEL, METHOD FOR INJECTING LIQUID CRYSTAL THEREOF AND APPARATUS FOR INJECTING LIQUID CRYSTAL

(71) Applicant: SILICON TOUCH TECHNOLOGY INC., Hsin-Chu (TW)

(72) Inventors: Cheng-Chieh Yang, Taipei City (TW); Anh Phuong Le, Hsinchu City (TW)

(73) Assignee: Silicon Touch Technology Inc., Hsin-Chu (TW)

(21) Appl. No.: 13/787,820

(22) Filed: Mar. 7, 2013

(30) Foreign Application Priority Data
May 24, 2012 (TW) 101209873
Jul. 27, 2012 (TW) 101127196

(51) Int. Cl. G02F 1/1341

(52) U.S. Cl. CPC G02F 1/1341
USPC 349/154; 349/189; 445/66

(57) ABSTRACT

A liquid crystal panel includes a first substrate, a second substrate, a sealant layer, and a liquid crystal layer. The second substrate is disposed opposite to the first substrate. The sealant layer is disposed between the first substrate and the second substrate for combining the first substrate and the second substrate. A plurality of openings is defined by the first substrate, the second substrate, and the sealant layer. The liquid crystal layer is disposed between the first substrate and the second substrate. The openings are configured to inject a liquid crystal material into space between the first substrate and the second substrate to form the liquid crystal layer by capillarity.

### BACKGROUND OF THE INVENTION

1. Field of the Invention

The present invention generally relates to a liquid crystal panel, a method for injecting liquid crystal thereof and an apparatus for injecting liquid crystal thereof, and more particularly, to a liquid crystal panel, a method for injecting liquid crystal thereof and an apparatus for injecting liquid crystal thereof, which provide at least two openings in a liquid crystal panel so that liquid crystal material can be injected to therefore form a liquid crystal layer.

2. Description of the Prior Art

Please refer to FIG. 1 and FIG. 2. FIG. 1 is a side-view schematic diagram showing a conventional liquid crystal panel, and FIG. 2 is a top-view schematic diagram showing the conventional liquid crystal panel. As shown in FIG. 1, a conventional liquid crystal panel 100 includes a first substrate 110, a second substrate 120, a first electrode layer 111, a second electrode layer 121, a first alignment film 112, a second alignment film 122, a sealant layer 130 and a liquid crystal layer 150. The first alignment film 112 and the first electrode layer 111 are disposed on a surface of the first substrate 110 opposite to the second substrate 120. The second alignment film 122 and the second electrode layer 121 are disposed on a surface of the second substrate 120 opposite to the first substrate 110. The sealant layer 130 is disposed between the first substrate 110 and the second substrate 120 for combining the first substrate 110 and the second substrate 120. The liquid crystal layer 150 is disposed between the first alignment film 112 and the second alignment film 122. The orientation of the liquid crystal layer 150 can be controlled by changing the electrical field between the first electrode layer 111 and the second electrode layer 121 in order to show certain display effect.

In conventional manufacturing technique for liquid crystal panels, there are several methods for forming liquid crystal layer, such as liquid crystal injection method and one drop filling (ODF) method. As shown in FIG. 2, a liquid crystal injection opening 140 is usually defined in a liquid crystal panel 100 by a pattern of a sealant layer 130 according to a conventional liquid crystal injection process. The liquid crystal panel 100 can be put in an enclosed chamber where air can be pumped out or pumped in so that a liquid crystal material can be injected into the liquid crystal panel 100 through the liquid crystal injection opening 140 to form a liquid crystal layer 150. Generally, the vacuum equipment is required in the conventional liquid crystal injection process, which causes relatively high equipment cost. On the other hand, when the conventional liquid crystal injection process is applied in manufacturing large-size panels, it often causes relatively long injection duration time since the flow speed of liquid crystal is not fast enough through this vacuum process. In addition, the ODF process is generally suitable for large-size and middle-size panels since it causes drawbacks in manufacturing small-size panel, such as relatively high precision requirements and the occurrence of unwanted bubbles. Therefore, in processes for manufacturing liquid crystal panels, how to inject liquid crystal in a more effective way and by a relatively low cost is always a mainstream development of this field.

### SUMMARY OF THE INVENTION

One objective of the present invention is to provide a liquid crystal, a method for injecting liquid crystal thereof and an apparatus for injecting liquid crystal thereof. At least two openings are disposed in the liquid crystal panel so that liquid crystal material can be injected into space in the liquid crystal panel by capillarity to therefore form a liquid crystal layer. The purpose of lowering manufacturing cost and equipment cost may be achieved accordingly.

To this end, according to one preferred embodiment of the present invention, a liquid crystal is provided. The liquid crystal panel includes a first substrate, a second substrate, a sealant layer and a liquid crystal layer. The second substrate is disposed opposite to the first substrate. The sealant layer is disposed between the first substrate and the second substrate for combining the first substrate and the second substrate. A plurality of openings is defined by the first substrate, the second substrate, and the sealant layer. The liquid crystal layer is disposed between the first substrate and the second substrate. The openings are configured to inject a liquid crystal material into space between the first substrate and the second substrate to form the liquid crystal layer by capillarity.

According to another preferred embodiment of the present invention, a method for injecting liquid crystal of a liquid crystal panel is provided. The method includes the following processes. First, a semi-finished liquid crystal panel is provided. The semi-finished liquid crystal panel includes a first substrate, a second substrate and a sealant layer. The second substrate is disposed opposite to the first substrate. The sealant layer is disposed between the first substrate and the second substrate for combining the first substrate and the second substrate. A plurality of openings is defined by the first substrate, the second substrate and the sealant layer. In a next step, at least one opening of the semi-finished liquid crystal panel is immersed into a liquid crystal material so as to have the liquid crystal material pass through the opening immersed in the liquid crystal material and be injected into space between the first substrate and the second substrate to form a liquid crystal layer by capillarity. Finally, the openings are sealed by a sealing material.

According to still another preferred embodiment of the present invention, a method for injecting liquid crystal of a liquid crystal panel is provided. The apparatus for injecting liquid crystal includes a liquid crystal container, a holder and an adjustment component. The liquid crystal container is used to contain a liquid crystal material. The holder is disposed above the liquid crystal container and is used to sustain a semi-finished liquid crystal panel. The semi-finished liquid crystal panel includes a first substrate, a second substrate and a sealant layer. The second substrate is disposed opposite to the first substrate. The sealant layer is disposed between the first substrate and the second substrate for combining the first substrate and the second substrate. A plurality of openings is defined by the first substrate, the second substrate and the sealant layer. The adjustment component is disposed above the holder and is used to adjust a position of the semi-finished liquid crystal panel supported by the holder so that at least one opening of the semi-finished liquid crystal panel is immersed into a liquid crystal material. The liquid crystal material passes through the opening immersed in the liquid crystal material and is injected into space between the first substrate and the second substrate to form a liquid crystal layer by capillarity.

According to yet another preferred embodiment of the present invention, an apparatus for injecting liquid crystal is provided. The apparatus includes a liquid crystal container, a first adjustment component and a second adjustment component. The liquid crystal container is used to contain a liquid crystal material. The first adjustment component is disposed above the liquid crystal container and is used to sustain a semi-finished liquid crystal panel and to adjust a position of the semi-finished liquid crystal panel. The semi-finished liquid crystal panel includes a first substrate, a second substrate and a sealant layer. The second substrate is disposed opposite to the first substrate. The sealant layer is disposed between the first substrate and the second substrate for combining the first substrate and the second substrate. A plurality of openings is defined by the first substrate, the second substrate and the sealant layer. The second adjustment component is disposed above the first adjustment component and is used to adjust the position of the semi-finished liquid crystal panel so that at least one opening of the semi-finished liquid crystal panel is immersed into the liquid crystal material. The liquid crystal material passes through the opening immersed in the liquid crystal material and is injected into space between the first substrate and the second substrate to form a liquid crystal layer by capillarity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a side-view schematic diagram showing a conventional liquid crystal panel.

FIG. 2 is a top-view schematic diagram showing the conventional liquid crystal panel.

FIG. 3 is a top-view schematic diagram showing a liquid crystal panel according to a preferred embodiment of the present invention.

FIG. 4 is a cross-sectional diagram taken along a line A-A′ in FIG. 3.

FIG. 5 and FIG. 6 are schematic diagrams showing a method for injecting liquid crystal of a liquid crystal panel according to a preferred embodiment of the present invention.

FIG. 7 is schematic diagram showing an apparatus for injecting liquid crystal according to a preferred embodiment of the present invention.

FIG. 8 is a schematic diagram showing an apparatus for injecting liquid crystal according to another preferred embodiment of the present invention.

FIG. 9 is a schematic diagram showing an apparatus for injecting liquid crystal according to another preferred embodiment of the present invention.

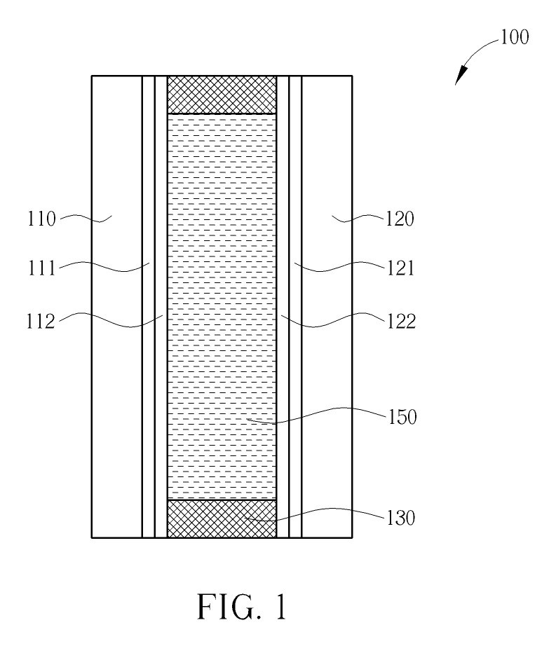

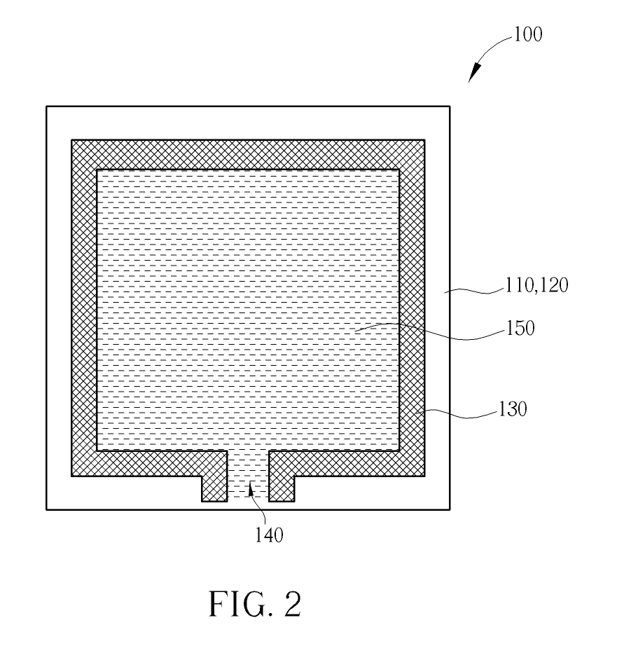

### DETAILED DESCRIPTION

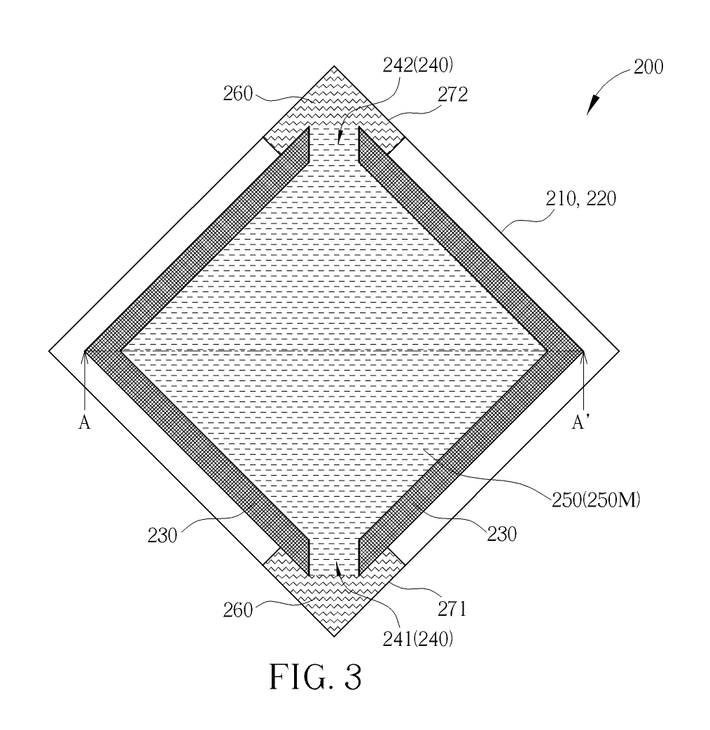

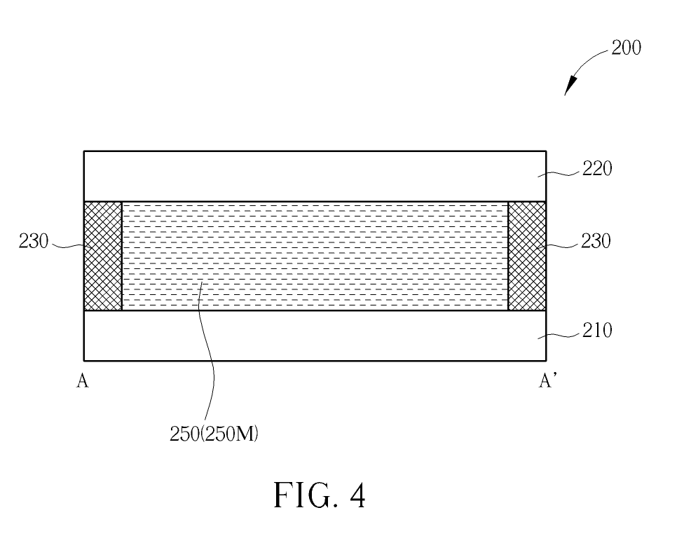

Please refer to FIG. 3 and FIG. 4. FIG. 3 is a top-view schematic diagram showing a liquid crystal panel according to a preferred embodiment of the present invention. FIG. 4 is a cross-sectional diagram taken along a line A-A′ in FIG. 3. It should be noted that all the figures are diagrammatic. Relative dimensions and proportions of parts of the drawings have been shown exaggerated or reduced in size, for the sake of clarity and convenience in the drawings. That is to say, the actual dimensions and proportions of parts of the drawings can be adjusted according to various design requirements. As shown in FIG. 3 and FIG. 4, a liquid crystal panel 200 is provided according to one preferred embodiment of the present invention. The liquid crystal panel 200 includes a first substrate 210, a second substrate 220, a sealant layer 230 and a liquid crystal layer 250. The second substrate 220 is disposed opposite to the first substrate 210. The first substrate 210 and the second substrate 220 may include rigid substrates, such as glass substrate or ceramic substrate, flexible substrates, such as plastic substrate, or other suitable substrates. The sealant layer 230 is disposed between the first substrate 210 and the second substrate 220 for combining the first substrate 210 and the second substrate 220. A plurality of openings 240 is defined by the first substrate 210, the second substrate 220 and the sealant layer 230. In other words, sealant layer 230 disclosed in this embodiment does not fully surround the periphery of the first substrate 210 and the second substrate 220. The place on the periphery of the first substrate 210 and the second substrate 220, where the sealant layer 230 is not disposed, can be used to accommodate the openings. Preferably, the openings 240 include a first opening 241 and a second opening 242 according to the present embodiment, but not limited to this. For example, more than two openings 240 can be applied in order to achieve required liquid crystal injection effect in various designs. In addition, the liquid crystal layer 250 is disposed between the first substrate 210 and the second substrate 220.

In this embodiment, the first opening 241 and the second opening 242 are used as passages to have a liquid crystal material 250M pass through. As a result, the liquid crystal material 250M can be injected into space between the first substrate 210 and the second substrate 220 to form the liquid crystal layer 250 by capillarity. It is worth noting that, the liquid crystal panel 200 disclosed herein is preferably a rectangular panel, but not limited to this. In addition, the liquid crystal panel 200 further includes a first apex 271 and a second apex 272. The first apex 271 and the second apex 272 are diagonally disposed. In this embodiment, the first opening 241 is preferably located at the first apex 271 and the second opening 242 is preferably located at the second apex 272. Through this specific design, an enhanced capillarity can be performed during the process where the liquid crystal material 250M is injected into space between the first substrate 210 and the second substrate 220. In other words, the first opening 241 and the second opening 242 are preferably respectively disposed on one of a pairs of diagonally opposite apexes of the liquid crystal panel 200 so as to enhance the capillarity during the injection of the liquid crystal material 250M, but not limited to this. According to other preferred embodiments of the present invention, there may be more than two openings respectively disposed within different regions of the liquid crystal panel 200, if required, so as to achieve the required capillarity during the injection of the liquid crystal material. It should be noted that the first substrate 210 and the second substrate 220 of the liquid crystal panel 200 may further includes electrode layers (not shown), alignment layers (not shown) or other parts, if required. Various kinds of modified configurations may be applied and the detailed description of which is omitted herein since these modified configures can be deducted by person skilled in the art.

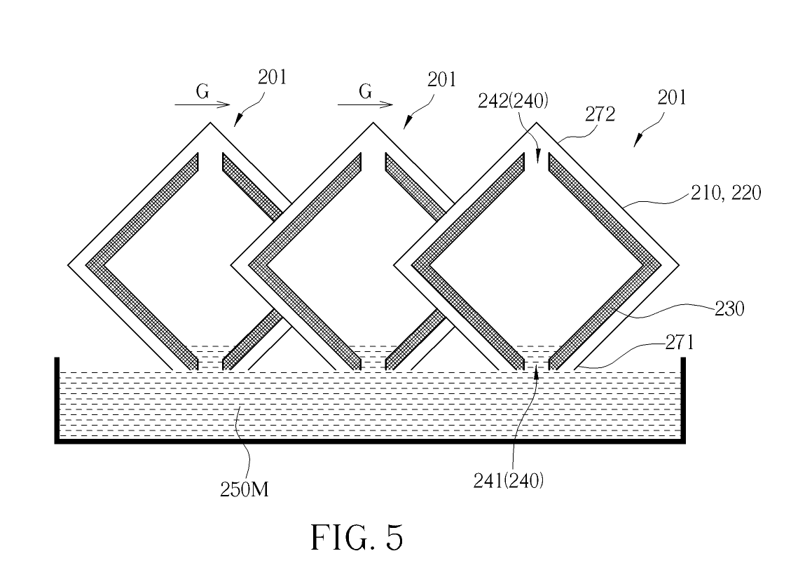

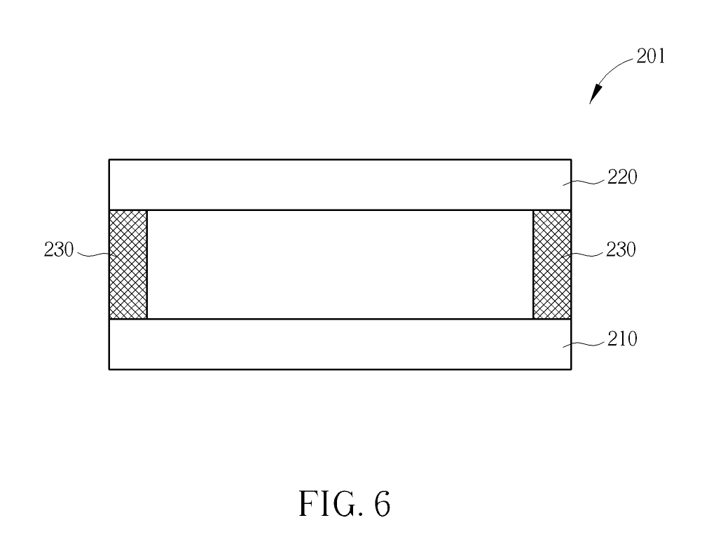

Please refer to FIG. 5 and FIG. 6 accompanied with FIG. 3. FIG. 5 and FIG. 6 are schematic diagrams showing a method for injecting liquid crystal of a liquid crystal panel according to a preferred embodiment of the present invention. The FIG. 6 is a schematic diagram showing a semi-finished liquid crystal panel. As shown in FIG. 3, FIG. 5 and FIG. 6, the present embodiment provides a method for injecting liquid crystal of a liquid crystal panel. The method disclosed herein includes the following processes. First, a semi-finished liquid crystal panel 201 is provided. The semi-finished liquid crystal panel 201 includes a first substrate 210, a second substrate 220 and a sealant layer 230. The second substrate 220 is disposed opposite to the first substrate 210. The sealant layer 230 is disposed between the first substrate 210 and the second substrate 220 for combining the first substrate 210 and the second substrate 220. The first substrate 210, the second substrate 220 and the sealant layer 230 can define a plurality of openings 240. Similarly, openings 240 disclosed in this embodiment may preferably include a first opening 241 and a second opening 242, but not limited to this. In a next step, the first opening 241 of the semi-finished liquid crystal panel 201 is immersed in the liquid crystal material 250M so that the liquid crystal material 250M may pass through the first opening 241 and be injected into space between the first substrate 210 and the second substrate 220 by capillarity to form a liquid crystal layer 250. Subsequently, a sealing material 260 (as shown in FIG. 3) is used to seal the first opening 241 and the second opening 242 in order to form the liquid crystal panel 200. In other words, the first opening 241 disclosed in this embodiment may be regarded as a liquid crystal injection opening and the opposite second opening 242 may be regarded as a vent opening so that capillarity can be performed effectively, but not limited to this. It is worth noting that, the advantage of having a pair of openings diagonally disposes at respective apexes is that the usage amount of the liquid crystal may be reduced effectively during the corresponding injection process. To put it more concretely, since the apexes generally have relatively small area comparing with other portions along the periphery of the liquid crystal panel, the contact area dipped into the liquid crystal material is therefore reduced. As a result, only small amount of the liquid crystal material will be absorbed or attached onto the surface of the semi-finished liquid crystal panel and almost no liquid crystal material will be wasted during the process for injection the liquid crystal material. According to other preferred embodiments of the present invention, more than two openings 240 may be provided and one of or a plurality of the openings 240 may be immersed into the liquid crystal material 250M so as to modify the capillarity during the injection of the liquid crystal material 250M. It is also worth noting that the method for injecting liquid crystal according to the present embodiment may further includes a process for forming a negative pressure state near the second opening 242. Since the liquid crystal material 250M prepared to be injected into the liquid crystal panel 200 is generally in a normal pressure state (i.e. 1 atm), when a negative pressure state is formed near the second opening 242 (also called vent opening), a Venturi effect can be generated and the injection speed of the liquid crystal material 250M is therefore increased. In this embodiment, the way to form the negative pressure state near the second opening 242 may include exhaling a gas G over the second opening 242. The gas G may preferably include high-pressure nitrogen or clean dry air (CDA), but not limited to this. The negative state may also be formed by other suitable gases.

Apart from the liquid crystal layer 250, the material properties and characteristic of other parts between the semi-finished liquid crystal panel 201 in the present embodiment and the liquid crystal panel 200 described above are almost similar, the description of which is therefore omitted for the sake of clarity. In other words, the semi-finished liquid crystal panel 201 may be regarded as in a state before the liquid crystal panel 200 is subject to the liquid crystal injection process. It is worth noting that, the semi-finished liquid crystal panel 201 disclosed in this embodiment preferably has a rectangular shape, but not limited to this. In addition, the semi-finished liquid crystal panel 201 further includes a first apex 271 and a second apex 272. The first apex 271 and the second apex 272 are diagonally disposed. In this embodiment, the first opening 241 is preferably located at the first apex 271 and the second opening 242 is preferably located at the second apex 272. Through this specific design, an enhanced capillarity can be performed during the process where the liquid crystal material 250M is injected into space between the first substrate 210 and the second substrate 220. The configuration of each of the openings 240 is similar to that described in the above liquid crystal panel 200, the detailed description of which is therefore omitted. It is worth noting that, the size of the semi-finished liquid crystal panel 201 according to this embodiment is preferably less than 1 square centimeter and the distance between the first substrate 210 and the second substrate 220 (also regarded as a cell gap) is preferably less than 30 micrometers so that effective capillarity can be generated, but not limited to this. By utilizing the design of the openings in the semi-finished liquid crystal panel 201 according to the present embodiment, the liquid crystal material 250M can be injected into space between the first substrate 210 and the second substrate 220 without vacuum environment so that the corresponding manufacturing and equipment cost are therefore reduced effectively.

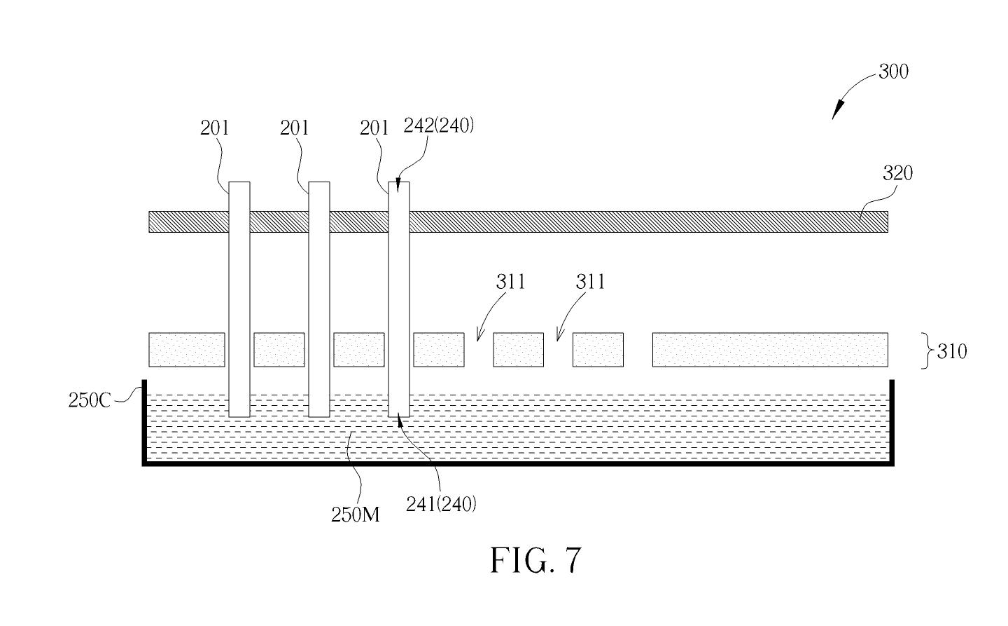

Please refer to FIG. 7 accompanied with FIG. 3, FIG. 5 and FIG. 6. FIG. 7 is a schematic diagram showing an apparatus for injecting liquid crystal according to a preferred embodiment of the present invention. As shown in FIG. 3, FIG. 5 and FIG. 7, the present embodiment provides an apparatus for injecting liquid crystal 300. The apparatus 300 includes a liquid crystal container 250C, a holder 310 and an adjustment component 320. The liquid crystal container 250C is used to contain liquid crystal material 250M. The holder 310 is disposed above the liquid crystal container 250C and is used to sustain the semi-finished liquid crystal panel 201. Since the detailed configuration of the semi-finished liquid crystal panel 201 is described in the above paragraph disclosing a method for injecting liquid crystal, the description of the same parts is therefore omitted for the sake of brevity. The adjustment component 320 is disposed above the holder 310 and is used to adjust a position of the semi-finished liquid crystal panel 201 sustained by the holder 310 so that the first opening 241 of the semi-finished liquid crystal panel 201 can be immersed into a liquid crystal material 250M. The liquid crystal material 250M can pass through the first opening 241 immersed in the liquid crystal material 250M and can be injected into space between the first substrate 210 and the second substrate 220 by capillarity to form a liquid crystal layer 250. In this embodiment, the holder 310 preferably includes a plurality of grooves 311 where semi-finished liquid crystal panel 201 can be disposed. A portion of the semi-finished liquid crystal panel 201 can penetrate the holder 310 and touch the liquid crystal material 250M in the liquid crystal container 250C. In other words, the holder is preferably a grooved-holder, but is not limited to this. In addition, the adjustment component 320 can touch the semi-finished liquid crystal panel 201 and vibrate slightly so that a position of each semi-finished liquid crystal panel 201 can be adjusted properly. In this way, the first opening 241 and the second opening 242 of each of the semi-finished liquid crystal panels 201 can be aligned precisely. The adjustment component 320 according to the present embodiment may further include a plurality of adjustment rollers (not shown), but not limited to this. By applying the apparatus for injecting liquid crystal 300 disclosed in this embodiment, the injection process of liquid crystal can be carried out automatically in a batch process.

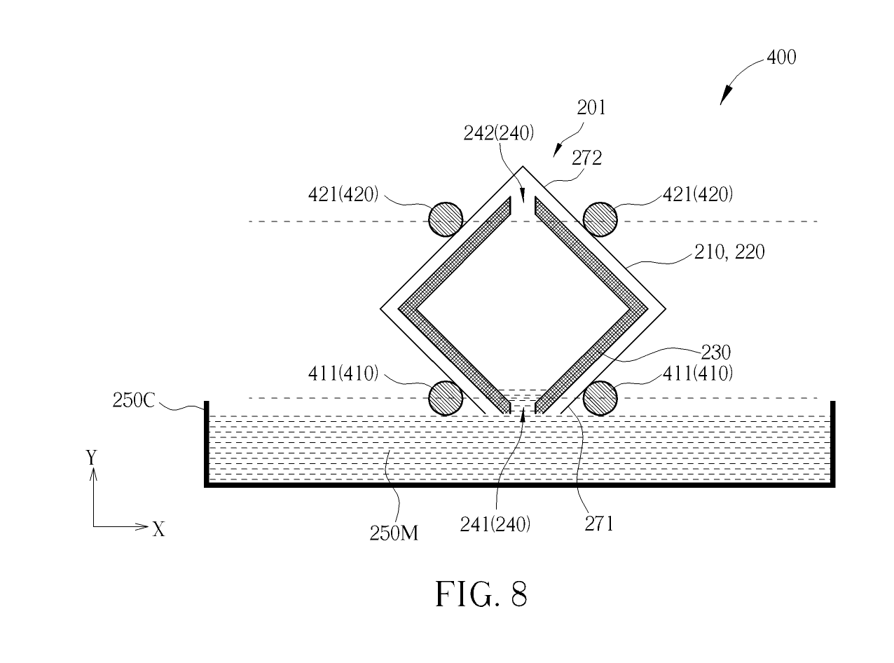

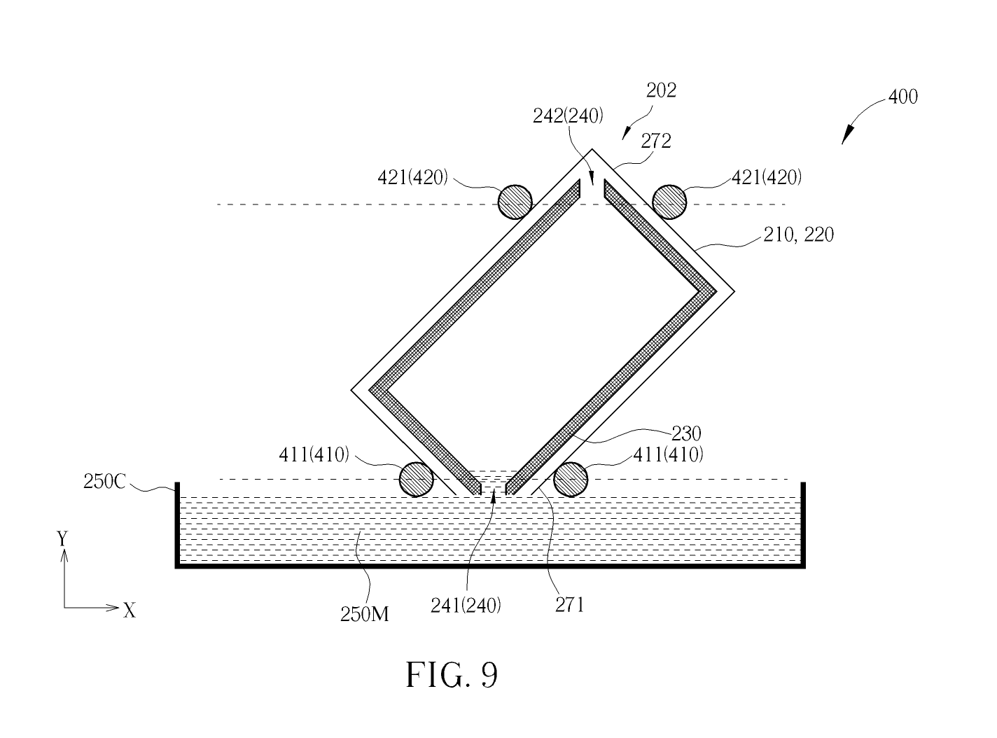

Please refer to FIG. 8 and FIG. 9 accompanied with FIG. 3. FIG. 8 is a schematic diagram showing an apparatus for injecting liquid crystal according to another preferred embodiment of the present invention. FIG. 9 is a schematic diagram showing an apparatus for injecting liquid crystal according to another preferred embodiment of the present invention. As shown in FIG. 3 and FIG. 8, the present embodiment provides an apparatus for injecting liquid crystal 400. The apparatus 400 includes a liquid crystal container 250C, a first adjustment component 410 and a second adjustment component 420. The liquid crystal container 250C is used to contain liquid crystal material 250M. The first adjustment component 410 is disposed above the liquid crystal container 250C and is used to sustain a semi-finished liquid crystal panel 201 and to adjust a position of the semi-finished liquid crystal panel 201. Since the detailed configuration of the semi-finished liquid crystal panel 201 is described in the above paragraph disclosing the method for injecting liquid crystal, the description of the same parts is therefore omitted. The second adjustment component 420 is disposed above the first adjustment component 410 and is used to adjust the position of the semi-finished liquid crystal panel 201 so that the first opening 241 of the semi-finished liquid crystal panel 201 is able to be immersed in the liquid crystal material 250M. The liquid crystal material 250M can pass through the first opening 241 immersed in the liquid crystal material 250M and can be injected into space between the first substrate 210 and the second substrate 220 by capillarity to form a liquid crystal layer 250. In this embodiment, the first adjustment component 410 may preferably include a plurality of first adjustment rollers 411, and the second adjustment component 420 may preferably include a plurality of second adjustment rollers 421, but not limited to this. Each first adjustment roller 411 and each second adjustment roller 421 can respectively approach the semi-finished liquid crystal panel 201 from the place above and under the semi-finished liquid crystal panel 201 and vibrate slightly so that the semi-finished liquid crystal panel 201 can be adjusted to a predetermined position. In this way, the first opening 241 and the second opening 242 of the semi-finished liquid crystal panel 201 can be aligned precisely. For example, as shown in FIG. 8, when the semi-finished liquid crystal panel 201 has a square shape, the two second adjustment rollers 421 in an upper position are preferably overlapped with each other along a horizontal direction X, and the two first adjustment rollers 411 in a lower position are also preferably overlapped with each other along the horizontal direction X. The center point of each of the two second adjustment rollers 421 is overlapped with the center point of each of the two first adjustment roller 411 along a vertical direction Y. In this way, the first opening 241 of the semi-finished liquid crystal panel 201 can point downwardly and second opening 242 of the semi-finished liquid crystal panel 201 can point upwardly, which can facilitate the subsequent liquid crystal injection. In addition, as shown in FIG. 9, when the shape of a semi-finished liquid crystal panel 202 is a rectangle, the first adjustment component 410 and the second adjustment component 420 may be moved along the horizontal direction X and/or the vertical direction Y in order to fit the shape of the semi-finished liquid crystal panel 202

To summarize, the prevent invention provides two oppositely disposed openings in a liquid crystal panel so that a liquid crystal material can be injected into space in the liquid crystal panel by capillarity to therefore form a liquid crystal layer. Since the liquid crystal injection process can be carried out without vacuum equipment, the corresponding manufacturing and equipment cost can therefore be reduced effectively. In addition, the present invention further provides an apparatus for injecting liquid crystal, which includes adjustment components, so that a liquid crystal injection process by capillarity can be carried out automatically in a batch process. In this way, the products can be manufactured in large quantity and in relatively low manufacturing cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal panel, comprising:
a first substrate;
a second substrate, disposed opposite to the first substrate;
a sealant layer, disposed between the first substrate and the second substrate for combining the first substrate and the second substrate, wherein a plurality of openings is defined by the first substrate, the second substrate, and the sealant layer; and
a liquid crystal layer, disposed between the first substrate and the second substrate, wherein the openings are configured to inject a liquid crystal material into a space between the first substrate and the second substrate to form the liquid crystal layer by capillarity.

2. The liquid crystal panel according to claim 1, further comprising a first apex and a second apex disposed diagonally to the first apex, wherein the openings include a first opening and a second opening, the first opening is disposed at the first apex and the second opening is disposed at the second apex.

3. A method for injecting liquid crystal of a liquid crystal panel, comprising:
providing a semi-finished liquid crystal panel, the semi-finished liquid crystal panel comprising:
a first substrate;
a second substrate, disposed opposite to the first substrate; and
a sealant layer, disposed between the first substrate and the second substrate for combining the first substrate and the second substrate, wherein a plurality of openings are defined by the first substrate, the second substrate, and the sealant layer;
immersing at least one of the openings of the semi-finished liquid crystal panel into a liquid crystal material so as to have the liquid crystal material pass through the opening immersed in the liquid crystal material and be injected into a space between the first substrate and the second substrate to form a liquid crystal layer by capillarity; and
sealing the openings by a sealing material.

4. The method for injecting the liquid crystal of the liquid crystal panel according to claim 3, wherein the liquid crystal panel further comprises a first apex and a second apex disposed diagonally to the first apex, wherein the openings include a first opening and a second opening, the first opening is disposed at the first apex, and the second opening is disposed at the second apex.

5. The method for injecting the liquid crystal of the liquid crystal panel according to claim 4, wherein the first opening is immersed in the liquid crystal material and the second opening is a vent opening.

6. The method for injecting the liquid crystal of the liquid crystal panel according to claim 5, further comprising forming a negative pressure state near the second opening.

7. The method for injecting the liquid crystal of the liquid crystal panel according to claim 6, wherein a way used to form the negative pressure state includes exhaling a gas over the second opening.

8. An apparatus for injecting liquid crystal, comprising:
a liquid crystal container for containing a liquid crystal material;
a holder, disposed above the liquid crystal container and configured to sustain a semi-finished liquid crystal panel, wherein the semi-finished liquid crystal panel comprises:
a first substrate;
a second substrate, disposed opposite to the first substrate; and
a sealant layer disposed between the first substrate and the second substrate for combining the first substrate and the second substrate, wherein a plurality of openings is defined by the first substrate, the second substrate, and the sealant layer; and
an adjustment component disposed above the holder and configured to adjust a position of the semi-finished liquid crystal panel sustained by the holder so that at least one of the openings of the semi-finished liquid crystal panel is immersed into a liquid crystal material, wherein the liquid crystal material passes through the opening immersed in the liquid crystal material and is injected into a space between the first substrate and the second substrate to form a liquid crystal layer by capillarity.

9. The apparatus for injecting the liquid crystal according to claim 8, wherein the semi-finished liquid crystal panel further comprises a first apex and a second apex disposed diagonally to the first apex, wherein the openings include a first opening and a second opening, the first opening is disposed at the first apex, and the second opening is disposed at the second apex.

10. An apparatus for injecting liquid crystal, comprising:
a liquid crystal container for containing a liquid crystal material;
a first adjustment component, disposed above the liquid crystal container and configued to sustain a semi-finished liquid crystal panel and to adjust a position of the semi-finished liquid crystal panel, the semi-finished liquid crystal panel including:
a first substrate;
a second substrate, disposed opposite to the first substrate; and
a sealant layer, disposed between the first substrate and the second substrate for combining the first substrate and the second substrate, wherein a plurality of openings is defined by the first substrate, the second substrate, and the sealant layer; and
a second adjustment component, disposed above the first adjustment component and configured to adjust the position of the semi-finished liquid crystal panel so that at least one of the openings of the semi-finished liquid crystal panel is immersed into the liquid crystal material, wherein the liquid crystal material passes through the opening immersed in the liquid crystal material and is injected into a space between the first substrate and the second substrate to form a liquid crystal layer by capillarity.

11. The apparatus for injecting the liquid crystal according to claim 10, wherein the semi-finished liquid crystal panel further comprises a first apex and a second apex disposed diagonally to the first apex, wherein the openings include a first opening and a second opening, the first opening is disposed at the first apex and the second opening is disposed at the second apex.

12. The apparatus for injecting the liquid crystal according to claim 10, wherein the first adjustment component comprises at least one first adjustment roller, the second adjustment component comprises at least one second adjustment roller, the first adjustment component and the second adjustment component are respectively configured to adjust the position of the semi-finished liquid crystal panel by approaching and slightly vibrating the semi-finished liquid crystal panel.
